(19) United States
(12) Patent Application Publication
(10) Pub. No.: US 2013/0111887 A1
(43) Pub. Date: May 9, 2013

(54) HYDRODYNAMIC CYCLE GENERATION TECHNOLOGY

(71) Applicant: James Kwok, Hope Island (AU)

(72) Inventor: James Kwok, Hope Island (AU)

(21) Appl. No.: 13/642,655

(22) PCT Filed: Apr. 14, 2011
(86) PCT No.: PCT/AU11/00430

§ 371 Date: Jan. 2, 2013

(30) Foreign Application Priority Data
Apr. 21, 2010 (AU) 2010901678
Jan. 27, 2011 (AU) 2011900255

(51) Int. Cl. F03B 17/02

(52) U.S. Cl. CPC F03B 17/02
USPC 60/325

(57) ABSTRACT

An energy generation apparatus comprising a storage vessel adapted to contain a first fluid, one or more evacuation vessels, each of the one or more evacuation vessels being divided into a first portion in fluid communication with the storage vessel and a second portion in fluid communication with a source of a second fluid, and energy generation means, wherein the flow of the first fluid from the storage vessel to the first portion of the evacuation vessel results in the evacuation of the second fluid from the second portion of the evacuation vessel such that the flow of the second fluid from the second portion of the evacuation vessel results in the actuation of the energy generation means.

### FIELD OF THE INVENTION

The present invention relates to an energy generation apparatus. In particular, the present invention relates to an energy generation apparatus that utilises hydrostatic pressure gradients in a body of fluid to generate energy.

### BACKGROUND ART

Traditionally, the generation of power, such as electrical power, has been achieved through the use of fossil fuels such as coal, natural gas and oil. However, in recent times, due to the decreasing reserves of fossil fuels and the environmental impact of their use in power generation, cleaner alternatives for the generation of power have become more popular.

Despite the fact that they are considerably more environmentally-friendly, these alternative power generation techniques (solar, wind, wave, geothermal etc) have struggled to gain widespread acceptance due to their inefficiencies in generating power, their high cost to establish in comparison to existing fossil fuel technology and their lack of aesthetic appeal including health concerns (such as wind farms).

Therefore, there would be an advantage if it were possible to provide apparatus for power generation that efficiently generated power without having a detrimental impact on the environment.

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### SUMMARY OF THE INVENTION

It is an object of the present invention to provide an energy generation apparatus which may overcome at least some of the abovementioned disadvantages, or provide a useful or commercial choice.

In one aspect, the invention resides broadly in an energy generation apparatus comprising a storage vessel adapted to contain a first fluid, one or more evacuation vessels, each of the one or more evacuation vessels being divided into a first portion in fluid communication with the storage vessel and a second portion in fluid communication with a source of a second fluid, and energy generation means, wherein the flow of the first fluid from the storage vessel to the first portion of the evacuation vessel results in the evacuation of the second fluid from the second portion of the evacuation vessel such that the flow of the second fluid from the second portion of the evacuation vessel results in the actuation of the energy generation means.

Any suitable storage vessel may be used in the energy generation apparatus. Preferably, however, the storage vessel is a tank or similar vessel in which a fluid may be retained. In some embodiments of the invention, a plurality of storage vessels may be present.

The storage vessel may be of any size, shape or configuration. However, in a preferred embodiment of the invention, the storage vessel is relatively tall in order to create a sufficient head of fluid in the storage vessel to ensure efficient operation of the apparatus. In embodiments of the invention in which a plurality of storage vessels are present, the storage vessels may be of the same height as one another, or different heights to one another. These vessels can be arranged or configured to communicate to each other in various forms including vertically or horizontally.

Preferably, the storage vessel is mounted to a support at a lower end thereof. Any suitable support may be used. For instance, the storage vessel may be mounted to the ground, a base (such as a concrete slab), foundations, a platform or the like. In some embodiments of the invention, the storage vessel may be mounted to a portable support, such as a transportable platform, vehicle, or fitted within a contained, crate or the like, so that the apparatus may be transported to different locations as required.

The storage vessel may be of any suitable cross-sectional shape. For instance, the storage vessel may be circular, square, rectangular, oval or any other shape in cross-section.

The first fluid may be any suitable fluid, such as, but not limited to water (including seawater, raw water, fresh water, recycled water etc), oil or mixture of oils or any other suitable liquid. If the apparatus is to be used in colder climates, a fluid such as glycol (or any other suitable low freezing point fluid) may be used as the first fluid.

While it is envisaged that the fluid level in the storage vessel will be relatively stable from cycle to cycle, it is possible that fluctuations in fluid level may occur due to a number of reasons, including evaporation, spillage, leakage or the like. Thus, in some embodiments of the invention, means for replenishing the fluid in the storage vessel may be provided. Any suitable means may be used, such as maintaining a reservoir or backup stock of the first fluid in fluid communication with the storage vessel via a tap, valve or the like. Alternatively, a constant feed of fresh first fluid may be provided to the storage vessel in order to maintain a constant level of first fluid. In other embodiments, additional first fluid may be added when required from barrels or the like.

As previously stated, the first portion of the one or more evacuation vessels is in fluid communication with the storage vessel. The first fluid may pass from the storage vessel to the first portion using any suitable technique. For instance, the first fluid may be fed under gravity to the first portion of the evacuation vessel. Alternatively, the first fluid may be pumped, siphoned or the like between the evacuation vessel and the storage vessel.

In embodiments of the invention in which multiple evacuation vessels are present, it is envisaged that the storage vessel will be in fluid communication with each of the first portions of each of the evacuation vessels.

In some embodiments, the apparatus may be provided with an equalization chamber in fluid communication with the storage vessel in which a portion of the first fluid may be stored. It is envisaged that the fluid level in the equalization chamber will be substantially identical to that in the storage vessel. To achieve this, it is preferred that the equalization chamber extends along at least a portion of the height of the storage vessel. The equalization chamber may be positioned internally to the storage vessel or externally to the storage vessel. In some embodiments of the invention, particularly those in which multiple evacuation vessels are present, a plurality of equalization chambers may be provided.

In some embodiments, at least one of the equalisation chambers may be provided with an equalizing reservoir associated with an upper region thereof. The equalising reservoir may be of any suitable size, shape or configuration and may be adapted to retain any suitable volume of fluid therein.

Preferably, the equalising reservoir is in fluid communication with both the equalisation chamber and the storage vessel.

It is envisaged that, in some embodiment of the invention, a plurality of equalisation chambers may each be provided with an equalizing reservoir. Alternatively, a single equalizing reservoir may be associated with a plurality of equalisation chambers. In other embodiments, each of the equalisation chambers may be provided with its own equalising reservoir.

Preferably, the equalising reservoir is provided with one or more moveable barriers therein. Any suitable moving barrier may be used, although in some embodiments of the invention, the moveable barrier may be a piston. Movement of the piston may be achieved using any suitable technique, such as gravity, fluid pressure, mechanical, hydraulic or pneumatic means, or any combination thereof. The purpose of the moveable barrier is to return fluid to the storage vessel, as well as to provide an equalising pressure when a force is applied from below the moveable barrier (i.e. from the equalisation chamber).

In some embodiments of the invention, the moveable barrier in the equalising reservoir may be associated with a moveable barrier in an evacuation chamber. In this way, the moveable barriers may be substantially reciprocating.

The moveable barrier may be provided with one or more openings therethrough to allow fluid to pass between the storage vessel and the equalisation chamber. Preferably, the one or more openings are provided with control means to prevent the unwanted flow of fluid, and to control the volume and timing of the flow of fluid. Any suitable control means may be provided, such as, but not limited to, one or more caps, screens, valves, or the like. Preferably, each of the one or more openings is provided with a valve to control the flow of fluid.

In a preferred embodiment, the equalization chamber comprises a pipe, conduit or the like attached to an external surface of the storage vessel and in fluid communication with the interior of the storage vessel through a first inlet located in an upper portion of the storage vessel and a second inlet located in a lower portion of the storage vessel. In this way, the fluid level in the equalization chamber is substantially identical to the fluid level in the storage vessel. Preferably, the equalization chamber is provided with at least one transfer conduit adapted to transfer the first fluid between the storage vessel and the evacuation vessel and vice versa. The transfer conduit may be of any suitable size, shape and configuration, although in a preferred embodiment of the invention, the transfer conduit is provided in a lower portion of the equalization chamber in order to ensure that the first fluid may be transferred from a relatively low level within the storage vessel.

In some embodiments of the invention, a plurality of transfer conduits may be provided from the equalization chamber to the evacuation vessel. In other embodiments, a single equalization chamber may be used to transfer the first fluid to two or more evacuation vessels. In this embodiment of the invention, one or more transfer conduits may extend between the equalization chamber and each evacuation vessel.

In preferred embodiments, the first fluid passes from the storage vessel to the evacuation vessel through the equalization chamber. Any suitable technique may be used for transferring the first fluid to the evacuation chamber, although in a preferred embodiment, the equalization chamber is provided with pumping means in an upper portion thereof adapted to assist in moving the first fluid between the storage vessel and the evacuation vessel. Due to the fact that the fluid level in the storage vessel is substantially that of the fluid level in the equalization chamber, the pumping means (which may be a pump, or any other suitable device) operates at minimal power usage. The pumping means may be operated continuously or intermittently as required.

The minimal power usage in the pumping means may be achieved by utilizing the property that water levels in a U shaped tube will seek to equalize. As a result, fluid movement from the one or more transfer conduits to the storage vessel will typically be required to overcome only a minimal static head. This principle of operation means that one or more equalisation chambers may be provided at varying heights on the storage vessel without compromising the minimal power usage advantage, while taller storage vessels will result in an increase in the hydrostatic pressure which may be harnessed as potential energy for conversion into power.

The flow of fluid through the one or more transfer conduits and into the evacuation vessel may be achieved solely through the use of the pumping means. Alternatively, additional means may be provided to assist the flow of the first fluid between the storage vessel and the evacuation chamber. Any suitable means may be provided, such as, but not limited to, one or more eductors adapted to create a Venturi effect to assist in the transfer of the first fluid between the storage vessel and the evacuation vessel.

In an alternative embodiment, the equalisation chamber may be provided with a piston or the like to assist in the transfer of fluid between the storage chamber and the evacuation chamber. In this embodiment of the invention, it is envisaged that the equalisation chamber may be provided with a plurality of inlets in fluid communication with the storage vessel, and a, plurality of outlets in fluid communication with the evacuation vessel (for instance, via the transfer conduits) and/or the storage vessel. Preferably, the plurality of inlets are provided at different heights in the storage vessel. In a preferred embodiment of the invention, each of the plurality of inlets and plurality of outlets is provided with a valve or the like. It is envisaged that the equalisation chamber may be provided with an equal number of inlets and outlets.

In one embodiment of the invention, the equalisation chamber may comprise two inlets in communication with the storage vessel. Preferably, the piston is positioned at a height between the two inlets, thereby dividing the equalisation chamber into a first chamber (positioned above the piston and in communication with a first inlet) and a second chamber, (positioned below the piston and in communication with a second inlet). As fluid enters and exits the equalisation chamber through the plurality of inlets and outlets, the piston may move in response to the flow of fluid. The movement of the piston may be used to generate power, for instance, by associating the piston with power generation means, such as a generator or the like.

In some embodiments of the invention, the first fluid may be transferred to the evacuation vessel through the transfer conduits, and returned to the storage vessel in the same manner. Alternatively, the apparatus may be provided with one or more return conduits through which the first fluid may flow from the evacuation vessel to the storage vessel. In this embodiment of the invention, the one or more transfer conduits and/or the one or more return conduits may be provided with non-return valves to ensure that the first fluid may flow in a single direction only through the conduits.

In an alternative embodiment of the invention, one or more intermediate chambers may be positioned between the storage vessel and one or more evacuation vessels. The one or more intermediate chambers may be used to evacuate fluid in the evacuation vessels and return it to the storage vessel. Thus, the intermediate chambers are in fluid communication with both the storage vessel and the evacuation vessels.

The one or more intermediate chambers may be of any suitable size, shape or configuration. In a preferred embodiment, each of the one or more intermediate chambers may comprise a moveable barrier located therein. Any suitable moveable barrier may be provided, although in a preferred embodiment of the invention, the moveable barrier comprises a piston, although it is envisaged that the moveable barrier could also comprise a helical shaft, pulley, screw conveyor, bladder, diaphragm, gear arrangement, pump, hydraulic actuator, pneumatic actuator, magnet or the like, or any combination thereof.

The movement of the moveable barrier within the intermediate chamber may be actuated by any suitable means. For instance, movement of the moveable barrier may be manual or automatic (for instance, through the use of a motor or the like). In an alternative embodiment, the moveable barrier in the intermediate chamber may be associated with moveable barriers in one or more evacuation vessels, such that movement of the moveable barriers in the one or more evacuation vessels produces a corresponding movement in the moveable barrier in the intermediate chamber.

The moveable barriers in the evacuation vessels may be associated with the moveable barriers in the intermediate chamber using any suitable technique, such as, but not limited to, connection means in the form of a line member (rope, chain, wire, cord, helical shaft, pulley, screw conveyor, bladder, diaphragm, gear, pump, hydraulic actuator, pneumatic actuator, magnet or the like, or any combination thereof) extending between the respective moveable barriers, electronic actuation means and so on.

The evacuation vessel may be of any suitable size, shape or configuration. For instance, any suitable cross-sectional shape may be provided to the evacuation vessel, such as square, round, hexagonal or the like. In some embodiments of the invention, the apparatus may be provided with a plurality of evacuation vessels. In this embodiment, each of the plurality of evacuation vessels may be of the same dimensions or different dimensions. Similarly, the evacuation vessels may be provided at the same height relative to the storage vessel, or different heights. Preferably, however, the plurality of evacuation vessels may be provided at different heights relative to the storage vessel to create a stacking effect, thereby allowing the apparatus to operate over a range of conditions.

In a preferred embodiment of the invention, the one or more evacuation vessels are provided with different dimension (diameter, height etc) to the storage vessel.

As previously stated, one or more evacuation vessels may be provided. In embodiments of the invention in which a plurality of evacuation vessels are provided, the evacuation vessels may be provided in the same orientation as one another or in different orientations to one another.

The first portion of the evacuation vessel may be a chamber adapted to retain a quantity of the first fluid during a certain part of the operational cycle of the apparatus, while the second portion of the evacuation vessel may be a chamber adapted to retain a quantity of the second fluid during a certain part of the operational cycle of the apparatus.

The second fluid may also be any suitable fluid, and may be the same fluid, or a different fluid, to the first fluid. In a preferred embodiment, the second fluid is chosen so as to cause the actuation of the energy generation means in the most efficient manner (i.e. with maximum transfer of energy to the energy generation means, and minimal frictional losses and the like). Thus, it is preferred that the second fluid is a relatively low-viscosity fluid.

In a preferred embodiment of the invention, the second fluid is a gas. Any suitable gas (or mixture of gases) may be used, although in some embodiments of the invention, the gas may be air.

In a preferred embodiment of the invention the first portion and the second portion of the evacuation chamber are separated from one another by a barrier, thereby preventing the first and second fluids from coming into contact with one another. The barrier may be of any suitable form, although in a preferred embodiment, the barrier may be a movable barrier. Thus, the volume of the first and second portions may change depending on the position of the barrier within the evacuation vessel. In some embodiments of the invention, a plurality of movable barriers may be provided. For instance, the first portion may be provided with a first barrier, and the second portion may be provided with a second barrier. In embodiments of the invention in which multiple barriers are present, the barriers may be moveable independently of one another. However, in a preferred embodiment, the barriers may be moveable in concert with one another. The barriers may be of the same or different dimensions (such as diameter and so on) to one another. In embodiments of the invention in which a plurality of evacuation vessels is present, the barriers in the evacuation vessels may be of the same, or different, dimensions to one another.

In a preferred embodiment of the invention, the barrier comprises a piston, such that a flow of the first fluid into the first portion of the evacuation vessel causes movement of the barrier in a first direction, thereby resulting in the evacuation of the second fluid from the evacuation vessel. Similarly, a flow of the second fluid into the second portion of the evacuation vessel may cause movement of the barrier in a second direction, thereby resulting in evacuation of the first fluid from the evacuation vessel.

In some embodiments, the movement of the barrier (particularly in the second direction) may be assisted at least partially by the use of any suitable drive means, such as, but not limited to, one or more motors. In this embodiment, the movement of the barrier using the drive means may assist in drawing a quantity of the second fluid into the second portion of the evacuation vessel.

Preferably, the first portion of the evacuation vessel may comprise one or more vents adapted to allow any air or other gas in the first portion to be evacuated to the atmosphere in order to prevent the creation of a vacuum within the first portion.

Alternatively, the evacuated air or gas may be passed over one or more turbines so as to generate power from the, flow of air or gas.

In a preferred embodiment, the second portion of the evacuation vessel comprises a second fluid inlet. The second fluid inlet may be connected to any suitable source of the second fluid, such as a reservoir or the like. Alternatively, in embodiments of the invention in which the second fluid is air, air may be drawn into the second portion through the second fluid inlet directly from the atmosphere. In some embodiments, the second fluid inlet is provided with means for preventing the second fluid from exiting the evacuation chamber through the second fluid inlet, such as a non-return valve.

In some embodiments of the invention, the second portion of the evacuation vessel may be made of a relatively expandable material so that the second portion may be inflatable. Alternatively, an inflatable device (such as a bladder or the like) may be positioned within the second portion of the evacuation vessel such that the flow of the second fluid into the second portion results in the inflation of the inflatable device. In alternative embodiments, the second portion may include an air-tight piston within a cylinder, storage cells or the like.

In a preferred embodiment, the inflatable device is associated with the barrier, such that movement of the barrier to evacuate the first portion results in a drawing in of the second fluid into the inflatable device. For instance, the inflatable device may be attached to the barrier. Once the inflatable device has reached the desired level of inflation, the first fluid may be allowed to enter the first portion, thereby causing movement of the barrier which, in turn, results in the evacuation of the second portion or the evacuation of the inflatable device positioned within the second portion.

The second fluid may be discharged from the second portion using any suitable discharge means. In some embodiments, however, the second fluid may be discharged through one or more pipes, conduits, manifolds, nozzles or the like, or a combination thereof. In a preferred embodiment, the discharge means may be provided with means for preventing the second fluid from returning to the second portion through the discharge means. Any suitable means may be provided, such as, but not limited to, a non-return valve.

As previously described, the flow of the second fluid exiting the second portion results in the actuation of the energy generation means. The energy generation means may be of any suitable form, such as, but not limited to rotational means in the form of one or more fans, turbines, propellers of the like associated with a generator or the like, such that the rotation of the rotational means results in the generation of power in the generator. Alternatively, the energy generation means may comprise gravitational means associated with a generator, such that movement of the gravitational means results in the generation of power in the generator. Any suitable generation means may be provided, such as one or more weights or the like.

In embodiments of the invention in which multiple evacuation vessels are present, each of the multiple evacuation vessels may be operated simultaneously, or at least one of the evacuation vessels may be operated such that its cycle is different to those of the other evacuation vessels. In some embodiments, the multiple evacuation vessels may be operated with varying cycle timings to minimise the amount of “dead” time (also known as a “void period”) when no power is being generated.

The number of evacuation vessels required for the apparatus is dependent on the power cycle. For instance, if the power cycle is 10 second for the power stroke to occur in each of the evacuation vessels, a total of ten evacuation vessels will be required in order to avoid void periods. It is envisaged that the apparatus of the present invention will be capable of generating power in the kWh or MWh range, depending on the size and specifications of the apparatus.

The energy generation means may be located exposed to ambient conditions. Alternatively, the energy generation means may be located in a generation chamber in fluid communication with the second chamber via the discharge means. In this way, the energy generation means may be protected from external interference (such as the wind and so on) and the flow of the second fluid across the rotational means may be controlled so as to result in the maximum possible transfer of energy. Once the second fluid has flowed past the rotational means, it may be captured and recycled to the second chamber or be discharged to the atmosphere.

In some embodiments of the invention, each generation chamber may be provided with a plurality of rotational means. Alternatively, discharged second fluid from a plurality of evacuation vessels may be combined and directed towards one or more rotational means.

In another aspect, the invention resides broadly in an energy generation apparatus comprising a storage vessel adapted to contain a first fluid, one or more evacuation vessel, each of the one or more evacuation vessels including a piston that divides the evacuation vessel into a first chamber in fluid communication with the storage vessel, and a second chamber in fluid communication with a source of a second fluid, and energy generation means, wherein the flow of the first fluid from the storage vessel to the first chamber causes movement of the piston resulting in the evacuation of the second fluid from the second chamber such that the flow of the second fluid from the second chamber results in the actuation of the energy generation means.

It is envisaged that the apparatus of the present invention may be used to generate power, for instance electrical power for use in any suitable application. However, it is also envisaged that the apparatus of the present invention could be used to generate propulsion for vehicles, and in particular, road-going vehicles or maritime vehicles.

It is also envisaged that the present invention could be used in conjunction with the energy generation apparatus of international patent application no. PCT/AU2008/001888, the contents of which are hereby incorporated by reference.

Table 1 below sets out the power calculations for an energy generation apparatus of the present invention at first, second and third stages.

TABLE 1
Power calculations at first, second and third stages

| Water Tower | 13 | | Effective Press. Head (m) | | 12 | | AWC off-take below T (m) | | 0.75 | PARASTIC-LOADS: | | | |
|---|---|---|---|---|---|---|---|---|---|---|---|---|---|
| Height (m) | | | | | | | | | | Rtc/Pump | Vol (m3/s) | F/R (N/s) | Head (m) |
| Retpec | Dia. (mm) | (m) | R (m) | 2PhiR | PhiRSq | L (m) | Vol (m3) | Vol (l) | | 1923.25 | 0.3925 | 3846.5 | 0.5 |
| Dimensions | 500 | 0.5 | 0.25 | 1.57 | 0.19625 | 1 | 0.19625 | 196.25 | | RPC Motor | | | |
| Retpec | Dia (mm) | m | R (m) | 2PhiR | PhiRSq | Vel (m/s) | Q (m3/s) | Q (l/s) | | 1000 | | | |
| Exit Nozzle | 350 | 0 35 | 0 [symbol] 75 | 1.099 | 0.0961625 | 15.3440542 | 1.47552261 | 1475.52261 | | Actuators | | | |
| Bernoulli's | Ph = | Ph (m) | 2 g (m/s2) | Vel (m/s) | | | | | | 200 | | | |
| Theorem | VSq/2 g | 12 | 19 62 | 15.3440542 | | | | | | Total (kWs) per-Power Cycle/tower | | | |
| Hidro- | Vol (m3) | 20% | Net Vol. | Rotor W | Effective H | PE (Nm) | Pwr:PC(kw) | PowerCycle | | 3.12325 | | | |
| Linear | 0.19625 | 0.03925 | 0.157 | 157 | 88 | 13553 496 | 13.553496 | 20-22 secs | | Total (kWs) for Total-Power-Cycle | | | |
| | | | | | | | | | | 141.3 | | | |
| | | | | | | | | | | Total (kWs) for TotalParasitic in Tot-P/C | | | |
| | | | | | | | | | | 18.7395 | 13.2622081 | % | |
| Power Calcs; | Force (N) | Vel (m/s) | Power (kW) | Power(MW) | | Press (kPa) | Q (m3/s) | Power (kW) | PowerCycle | Avail Power | 6 AWC | 12 AWC | |
| Retpec | 23 55 | 1 | 23.55 | 0 02355 | | 120 | 0.19625 | 23.55 | 6-8 secs | kW | 23.55 | 47.1 | |

Hydrodynamic-Fan Generator at Second-Stage.

| Water Tower | 11 | | Effective Press. Head (m) | | 9 | | AWC off-take below T (m) | | 9 | | | |
|---|---|---|---|---|---|---|---|---|---|---|---|---|
| Height (m) | | | | | | | | | | | | |
| Retpec | Dia. (mm) | (m) | R (m) | 2PhiR | PhiRSq | L (m) | Vol (m3) | Vol (l) | | | | |
| Dimensions | 500 | 0.5 | 0 25 | 1 57 | 0.19625 | 1 | 0.19625 | 196.25 | | | | |
| Retpec | Dia (mm) | m | R (m) | 2PhiR | PhiRSq | Vel (m/s) | Q (m3/s) | Q (l/s) | | | | |
| Exit Nozzle | 150 | 0 15 | 0.075 | 0.471 | 0.0176625 | 13.2883408 | 0.23470532 | 234.705319 | | | | |
| Bernoulli's | Ph = | Ph (m) | 2 g (m/s2) | Vel (m/s) | | | | | | | | |
| Theorem | VSq/2 g | 9 | 19 62 | 13.2883408 | | | | | | | | |
| Hidro- | Vol (m3) | 20% | Net Vol. | Rotor W | Effective H | PE (Nm) | Pwr:PC(kw) | PowerCycle | | | | |
| Linear | 0.19625 | 0 03925 | 0.157 | 157 | 6 | 9241.02 | 9.24102 | 20-22 secs | N/A | | | |
| Power Calcs; | Force (N) | Vel (m/s) | Power (kW) | Power(MW) | | Press (kPa) | Q (m3/s) | Power (kW) | PowerCycle | Avail Power | 6 AWC | 12 AWC |
| Retpec | 17.6625 | 1 | 17. [symbol] 625 | 0 0176625 | | 90 | 0 19625 | 17.6625 | 6-8 secs | kW | 17.6625 | 35 325 |

Hydrodynamic-Fan Generator at Third-Stage.

| Water Tower | 13 | | Effective Press. Head (m) | | 6 | | AWC off-take below T (m) | | 6 | | | |
|---|---|---|---|---|---|---|---|---|---|---|---|---|
| Height (m) | | | | | | | | | | | | |
| Retpec | Dia. (mm) | (m) | R (m) | 2PhiR | PhiRSq | L (m) | Vol (m3) | Vol (l) | | | | |
| Dimensions | 500 | 0.5 | 0.25 | 1.57 | 0. [symbol] 9625 | 1 | 0.19625 | 196.25 | | | | |
| Retpec Exit | Dia (mm) | m | R (m) | 2PhiR | PhiRSq | Vel (m/s) | Q (m3/s) | Q (l/s) | | | | |
| Nozzle | [symbol] 50 | 0.15 | 0.075 | 0.471 | 0.0176625 | 10.8498848 | 0. [symbol] 9163609 | 191.63609 | | | | |
| Bernoulli's | Ph = | Ph (m) | 2 g (m/s2) | Vel (m/s) | | | | | | | | |
| Theorem | VSq/2 g | 6 | 19.62 | 10.8498848 | | | | | | | | |
| Hidro- | Vol (m3) | 20% | Net Vol. | Rotor W | Effective H | PE (Nm) | Pwr: PC(kw) | PowerCycle | | | | |
| Linear | 0.19625 | 0.03925 | 0.157 | 157 | 3 | 4620.51 | 4.62051 | 20-22 secs | N/A | | | |
| Power Calcs; | Force (N) | Vel (m/s) | Power (kW) | Power(MW) | | Press (kPa) | Q (m3/s) | Power (kW) | PowerCycle | Avail Power | 6 AWC | 12 AWC |
| Retpec | 11.775 | 1 | 11.775 | 0.011775 | | 60 | 0.19625 | 11.775 | 6-8 secs | kW | 11.775 | 23.55 |
| | | | | | | | | | | | 52.9875 | 105.975 |

[symbol]

indicates data missing or illegible when filed

### BRIEF DESCRIPTION OF THE DRAWINGS

An embodiment of the invention will be described with reference to the following drawings in which:

FIG. 1 illustrates a side view of an energy generation apparatus according to an embodiment of the present invention;

FIG. 2 illustrates a plan view of an energy generation apparatus according to an embodiment of the present invention;

FIG. 3 illustrates a plan view of an energy generation apparatus according to an alternative embodiment of the present invention;

FIG. 4 illustrates sectional views of an energy generation apparatus according to an alternative embodiment of the present invention;

FIG. 5 illustrates a view of an evacuation vessel according to an alternative embodiment of the present invention;

FIG. 6A-6B illustrate side views of storage vessels according to embodiments of the present invention;

FIG. 7 illustrates a cross-sectional view of an equalisation chamber according to an embodiment of the present invention;

FIG. 8 illustrates a detailed partial view of an energy generation apparatus according to an embodiment of the present invention;

FIG. 9 illustrates a detailed partial view of an energy generation apparatus according to an embodiment of the present invention;

FIG. 10 illustrates a detailed partial side elevation of an energy generation apparatus according to an embodiment of the present invention;

FIG. 11 illustrates a plan view of an energy generation apparatus according to an embodiment of the present invention;

FIG. 12A illustrates an energy and mass balance in a traditional coal fired power station; and

FIG. 12B illustrates an energy and mass balance in an energy generation apparatus according to embodiments of the present invention.

### DETAILED DESCRIPTION OF THE DRAWINGS

It will be appreciated that the drawings have been provided for the purposes of illustrating preferred embodiments of the present invention and that the invention should not be considered to be limited solely to the features as shown in the drawings.

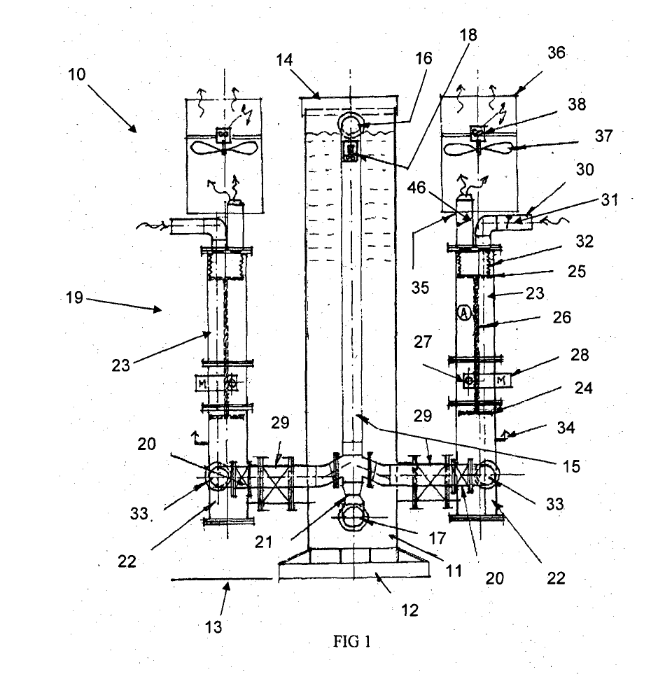

In FIG. 1 there is illustrated an energy generation apparatus 10 according to an embodiment of the present invention. The apparatus 10 comprises a storage vessel 11 in the form of a water tank mounted to a base 12 at ground level 13. The storage vessel 11 is substantially full of a first fluid (water) and a lid 14 is placed on the top of the storage vessel 11 to prevent water loss through evaporation, or contamination of the water in the storage vessel 11.

An equalization chamber in the form of a pipe 15 is attached to an outer surface of the storage vessel and is in fluid communication with the storage vessel 11 through an upper inlet 16 and a lower inlet 17. A pump 18 is located in an upper portion of the pipe 15 and is adapted to pump the first fluid from the storage vessel to the evacuation vessel 19 through transfer conduits 20.

To assist in the transfer of fluid, an educator 21 is located in a lower portion of the pipe 15 in order to create a Venturi effect.

The evacuation vessel 19 is divided into a first portion 22 (or water chamber) and a second portion 23 (or air chamber). The first portion 22 and second portion 23 are divided from one another by a first portion moveable barrier 24 and a second portion moveable barrier 25, in the form of pistons. The pistons 24, 25 are connected to one another by a shaft 26 such that movement of one piston results in a corresponding movement of the other piston. Movement of the shaft 26 may be assisted by a motor 27 on a gear and rack arrangement 28.

During an operational cycle, the motor 27 will be actuated to move the pistons 24, 25 downwardly so as to evacuate the water chamber 22. Water will be evacuated from the water chamber 22 through the return conduit 29 and into the storage vessel 11. As the pistons 24, 25 move, air is drawn in to the air chamber 23 through the air inlet 30. The air inlet 30 is fitted with a non-return valve 31 to prevent air from escaping through the inlet 30.

As air enters through the inlet 30, it inflates an inflatable bladder 32 positioned within the air chamber 23 and attached to the piston 25 such that downward movement of the piston 25 causes the volume of the inflatable bladder 32 to increase.

When the inflatable bladder 32 is at a desired level of inflation, water from the storage vessel 11 may be pumped into the water chamber 22 through inlet 33. As the water enters the water chamber 22, any air in the water chamber 22 may be evacuated through air vent 34. The flow of water into the water chamber 22 forces the pistons 24, 25 to move upwardly within the evacuation vessel 19, thereby causing air in the inflatable bladder 32 to be expelled through a discharge pipe 35 and into a generation chamber 36. The discharge pipe 35 is provided with a non-return valve 46 to prevent the flow of air back into the air chamber 23.

Air entering the generation chamber 36 flows past a turbine 37 associated with a generator 38 whereby the rotation of the turbine 37 results in the generation of power. The air then exits the generation chamber 36 into the atmosphere.

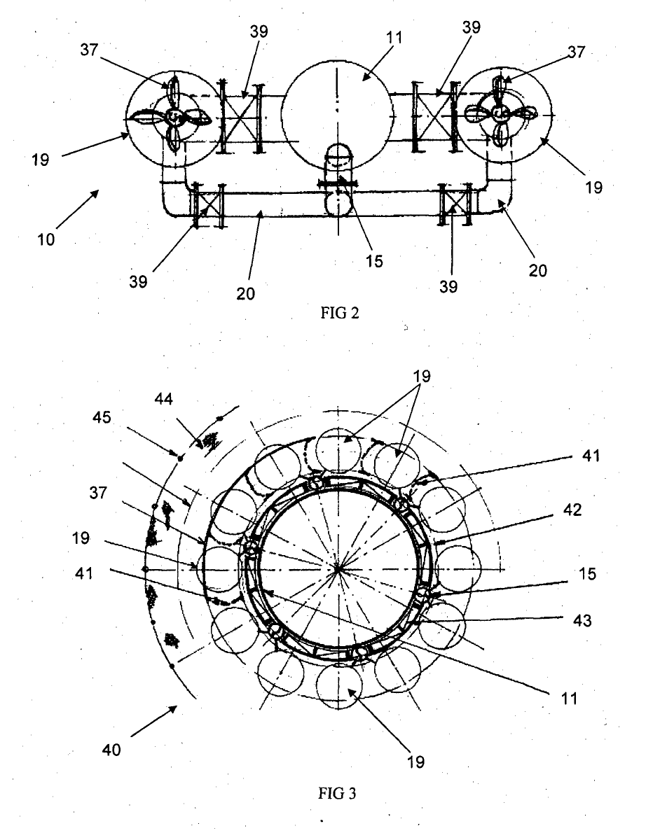

In FIG. 2 a plan view of an energy generation apparatus 10 according to an embodiment of the present invention is illustrated. In this Figure it may be seen that fluid from the storage vessel 11 is pumped to the evacuation vessels 19 via the equalization chamber 15 and the transfer conduits 20. Water is returned from the evacuation vessels 19 through the return conduits 29. Both the transfer conduits 20 and the return conduits 29 are provided with valves 39 that allow for the evacuation vessels 19 to be isolated from the storage vessel 11 is required.

The turbines 37 associated with each evacuation vessel 19 may also be clearly seen in this Figure.

In FIG. 3, a plan view of an energy generation apparatus 40 according to an alternative embodiment of the invention is illustrated. In this Figure, the apparatus 40 comprises a storage vessel 11 and twelve evacuation vessels 19 positioned thereabout. Six equalization chambers 15 are also provided, each of the equalization chambers 15 being in fluid communication with two of the evacuation vessels 19.

A single turbine 37 is provided having a plurality of turbine blades 41. A rotor 42 and stator 43 assembly is provided, with the stator 43 being attached to the storage vessel 11.

In the embodiment of the invention illustrated in FIG. 3, a walkway 44 and handrail 45 is provided to allow a user to observe and access the apparatus 40 (for maintenance and the like) as required.

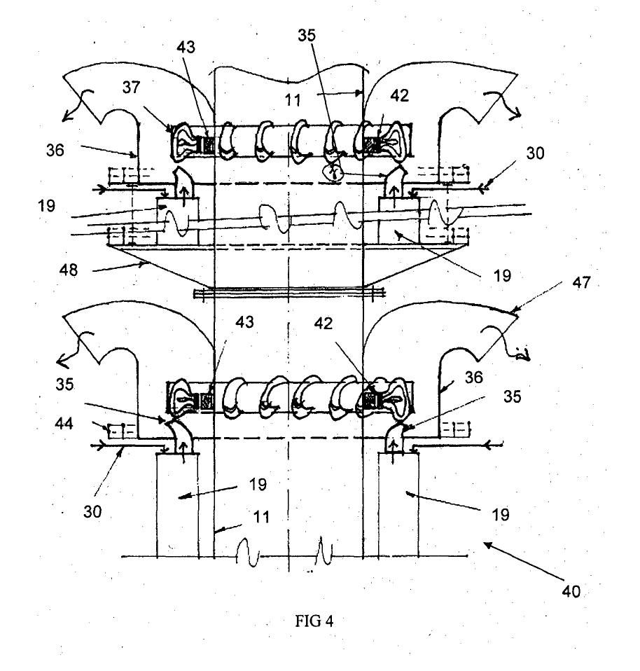

In FIG. 4, sectional views of an energy generation apparatus 40 according to an alternative embodiment of the present invention are shown. The arrangement shown in FIG. 4 is that of a “stacked” apparatus 40 in which a rotor 42 and stator 43 assembly is provided at each of two levels on the storage vessel 11, along with a turbine 37. In each of the upper assembly (shown in the upper portion of the Figure) and the lower assembly (shown in the lower portion of the Figure) the evacuation vessels 19 may be seen. Air enters the evacuation vessels 19 through the air inlet 30 and is expelled from the evacuation vessels 19 through the discharge pipe 35 directly onto the rotors 42.

The rotor 42 and stator 43 are housed at least partially within the generation chamber 36, and exhaust ports 47 are provided for the air to return to the atmosphere.

The upper assembly is supported by a bracket or platform 48 attached to the storage vessel 11.

The access walkway 44 may also be more clearly seen in this Figure.

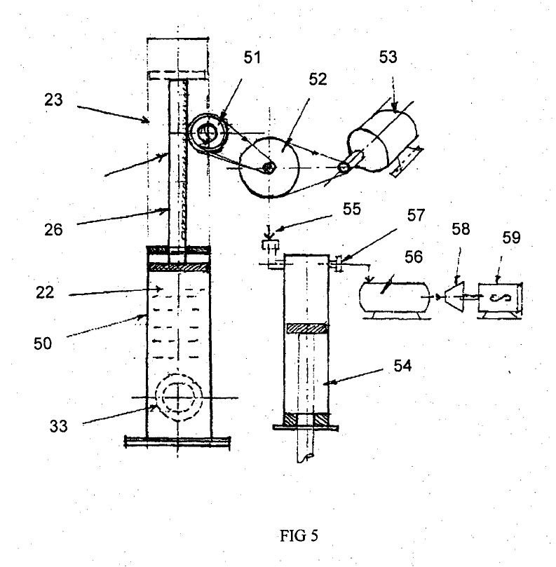

Turning now to FIG. 5, a view of an evacuation vessel 50 according to an alternative embodiment of the present invention is shown. The water chamber 22 is in fluid communication with the storage vessel (not shown) via an inlet 33. A piston 24 forms a moveable barrier between the water chamber 22 and the air chamber 23. In this embodiment of the invention, no second piston in the air chamber 23 is present.

As the shaft 26 moves within the evacuation vessel 50, the shaft 26 operates as a rack to operate a pinion gear 51 which in turn causes the rotation of a flywheel 52 and generator pulley 53 to generate electricity.

Alternatively, the shaft 26 could be used as a hydraulic or pneumatic cylinder and ram, comprising a fluid inlet port 55, and wherein compressed fluid is stored in a pressure storage cell 56 via a regulated port 57. The high pressure fluid in the storage cell 56 may be released as required to an air or pneumatic expander turbine 58 to actuate a generator 59 to generate electricity.

It is envisaged that the evacuation vessel 50 could be positioned vertically or horizontally, and could be provided as a tandem arrangement, with a central water chamber and an air chamber on either side thereof.

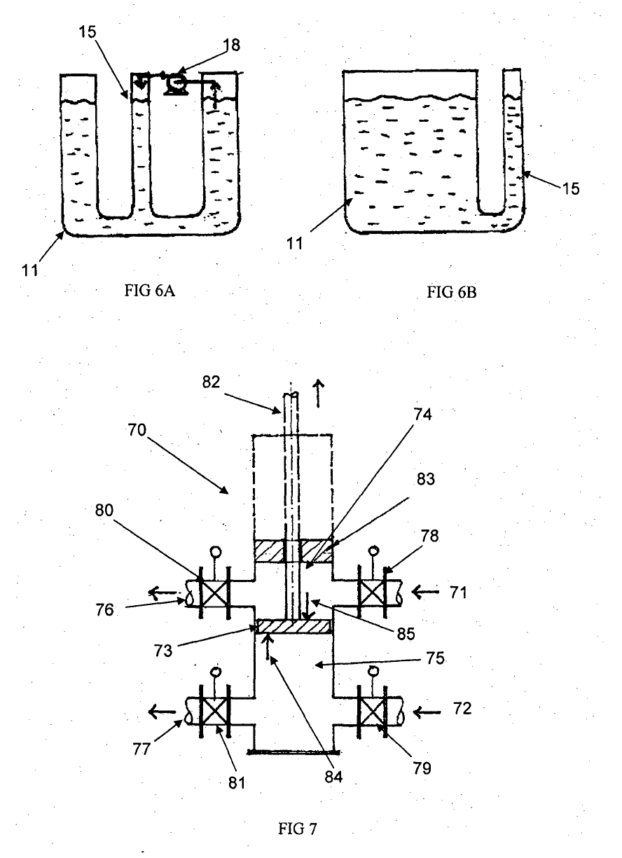

In FIGS. 6A and 6B there is illustrated side views of storage vessels 11 according to embodiments of the present invention. In FIG. 6A the storage vessel 11 is provided with an equalisation chamber 15 in fluid communication with the storage vessel 11 such that the fluid level in each is equalized. The barometric pressure at the surface of the equalisation chamber 15 is relatively low (due to its small diameter) compared to the storage vessel 11. A pump 18 is used to pump fluid from the storage vessel 11 into the equalisation chamber 15 so as to cause the movement of fluid, for instance to an evacuation vessel (not shown).

In FIG. 6B an alternative storage vessel 11 is shown, and it is envisaged that this embodiment will be more commonly used in the apparatus of the present invention. Water reticulation by a pump (not shown) between the storage vessel 11 and the equalisation chamber 15 at the top of the vessel 11 may be achieved with minimal head and therefore minimal power usage.

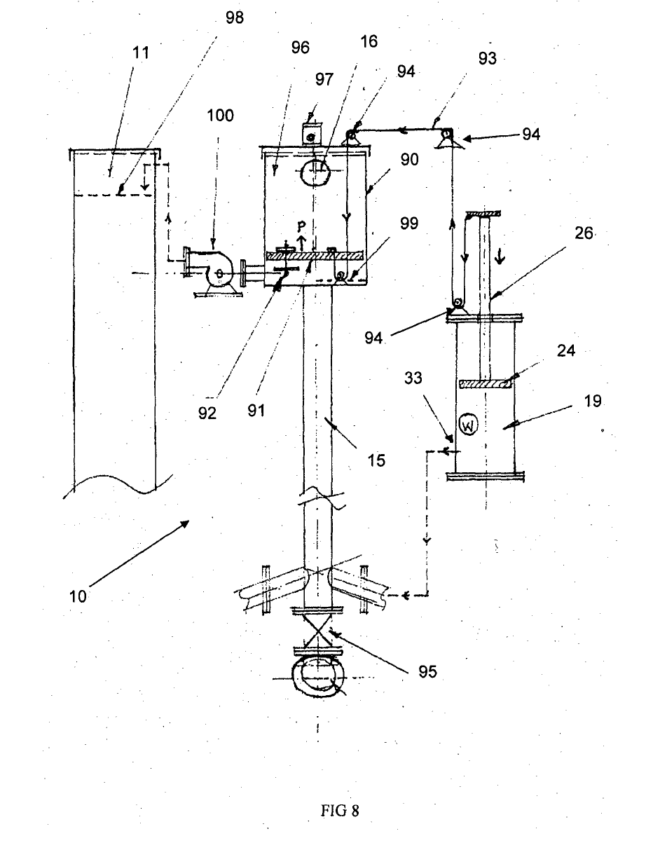

In FIG. 7, a cross-sectional view of an equalisation chamber 70 according to an alternative embodiment of the invention is illustrated. In this Figure, the equalisation chamber 15 is provided with a first inlet 71 and a second inlet 72, both of which are in fluid communication with a storage vessel (not shown) at different heights in the storage vessel. A piston 73 is positioned within the equalisation chamber 70 at a point between the first inlet 71 and the second inlet 72 so as to create a first chamber 74 and a second chamber 75. A first outlet 76 and a second outlet 77 return water to the storage vessel (not shown) from the first chamber 74 and second chamber 75 respectively. Each of the inlets and outlets is provided with a valve 78, 79, 80, 81.

The piston 73 is associated with a shaft 82 which passes through a fixed shaft support 83.

In use, valve 79 is opened and valves 78 and 81 are closed. Valve 80 is opened to allow fluid in the first chamber 74 to exit the first chamber 74 through outlet 76. The hydrostatic pressure from the storage vessel (not shown) creates a pressure force in the direction indicated by arrow 84 thereby causing an upward movement of the piston 73 creating a thrust that may be harnessed for energy conversion (by using gases, liquids, a rack and pinion arrangement or the like). The closing of valves 78 and 81 results in optimum hydrostatic pressure force to be harnessed.

When the valve 78 is opened, valves 79 and 80 are closed. When valve 81 is also opened, the pressure force indicated by arrow 85 causes the piston 73 to move downwardly without the use of motors and the fluid is evacuated from chamber 75 through outlet 77. The closing of valves 79 and 80 means no opposing pressure exists and the piston 73 movement may be optimized and achieved with minimal power usage in the overall cycle. This process may be repeated continuously or when required.

In FIG. 8, there is shown a detailed partial view of an energy generation apparatus 10 according to an embodiment of the present invention. In this Figure, an equalizing reservoir 90 is positioned at an upper end of the equalisation chamber 15. The equalizing reservoir 90 is provided with a piston 91 adapted to force water in the equalizing reservoir 90 to flow to the storage vessel 11 through the upper port 16. In addition, the piston 91 acts to equalize pressure in the equalizing reservoir 90 when a force is applied from below via the equalisation chamber 15.

The equalizing reservoir 90 is also provided with a valve 92 adapted to allow water to enter the equalizing reservoir 90 at a point above the piston 91 and subsequently exit through upper port 16. Upward movement of the piston 91 within the equalizing reservoir 90 is achieved through the use of a motor 97 positioned above the equalizing reservoir 90. Typically, the valve 92 will be shut to allow the piston 91 to move upwardly due to a force applied from the equalisation chamber 15 below.

This upward movement of the piston 91 actuates a cable 93 associated with a plurality of pulleys 94 and results in the downward movement of the shaft 26. This movement of the shaft 26 results in the equalisation of pressure in an evacuation chamber 19, thereby causing the shaft 26 and moveable barrier 24 (piston) to move downwardly and evacuate any water from the evacuation chamber 19 below the moveable barrier 24 through port 33. This action will allow hydrostatic pressure to be exerted on the piston 24 when a valve (not shown) positioned between port 33 and the equalisation chamber 15 is opened, thereby allowing the cycle to repeat.

When valve 95 is closed the water below the piston 91 passes into an upper portion 96 of the equalizing reservoir 90 through valve 92. Motor 97 actuates to move the piston 92 upwardly, thereby forcing water in the upper portion 96 to be evacuated through port 16 to the storage vessel 11. When this occurs, the water level 98 in the storage vessel 11 will be higher than the water level 99 in the equalizing reservoir 90.

When the valve 95 is opened, the water level 98 in the storage vessel 11 and the water level 99 in the equalizing reservoir 90 will equalize. This equalizing force is applied to the piston 91 and is transferred to the shaft 26 and piston 24, which, in turn, evacuates water from the evacuation chamber 19. Thus, the system is prepared for a repeat cycle in which the piston 24 is subjected to hydrostatic pressure when the valve (not shown) positioned between port 33 and the equalisation chamber 15 is opened.

Water in the equalizing reservoir 90 below the piston 91 may be returned to the storage vessel 11 via pump 100. In this embodiment of the invention, the use of the motor 97 to move the piston 91 is not necessary.

The pressure equalizing principles can be explained using the following computations:

If the storage vessel 11 has a diameter of 1000 mm and a height of 10 m, the equalizing reservoir diameter is 1000 mm, and its area is 0.8 m². The diameter of the evacuation chamber 19 and the piston 24 is 350 mm and their area is 0.096 m².

The hydrostatic pressure exerted at the valve (not shown) positioned between port 33 and the equalisation chamber 15 is approximately 100 kPa (being 10 kPa/m depth), and the distance between the water level 98 in the storage vessel 11 and the water level 99 in the equalizing reservoir 90 is 1300 mm.

The force exerted at the piston 24 is 9.6 kN (being pressure×area). Thus, in order for the piston 24 and shaft 26 to evacuate the evacuation chamber 19, the force that must be overcome is 9.6 kN. Thus, the piston 24 must move downwards for, say 1000 mm.

The piston 91 in the equalizing reservoir 90 will be subjected to a water force when valve 95 is opened, and the water head will be equal to the difference in water level in the equalizing reservoir 90 (i.e. 1300 mm). On this basis, the force below the piston 91 is 10.4 kN (being pressure×area). Thus, the piston 91 will be capable of overcoming the force under piston 24 of 9.6 kN, thereby allowing piston 24 to move downwards with the equalizing pressure to cause the evacuation of the evacuation chamber 19. The system will then be ready for the repeat cycle in which hydrostatic pressure is introduced when the valve (not shown) positioned between port 33 and the equalisation chamber 15 is opened.

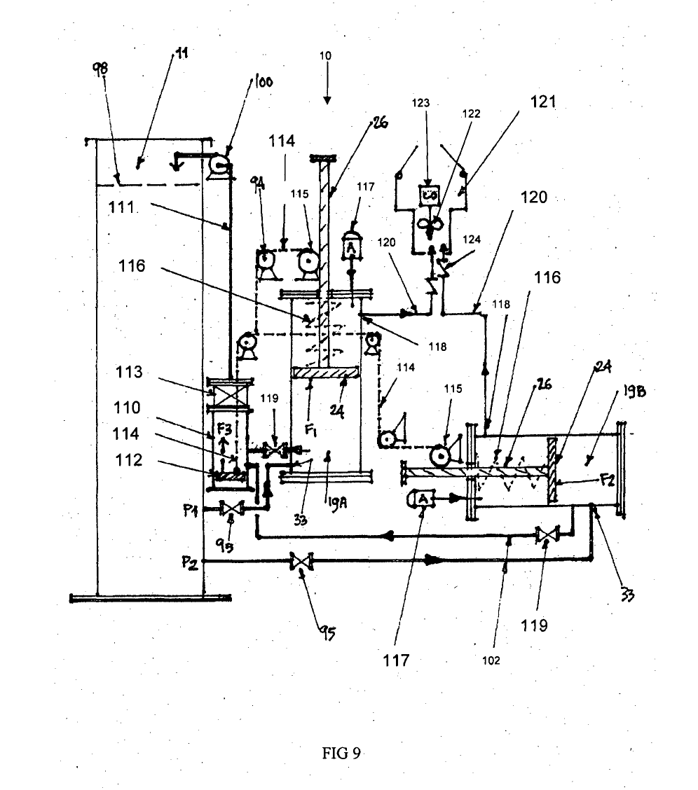

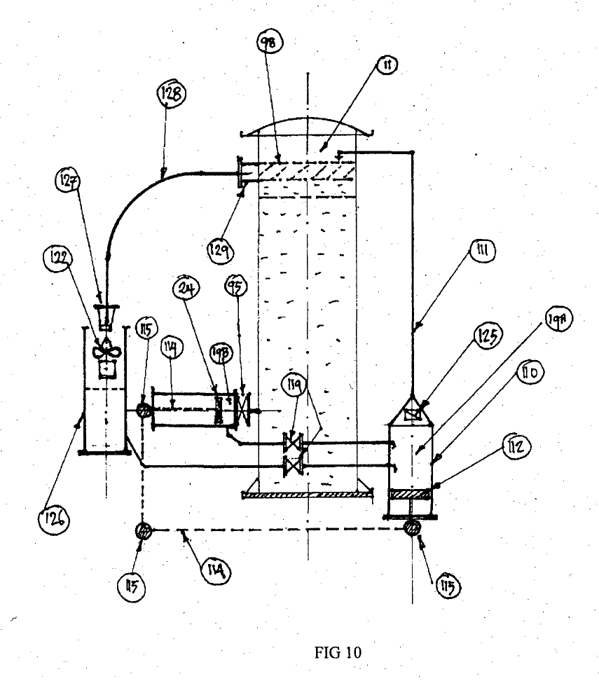

In FIG. 9, there is shown a detailed partial view of an energy generation apparatus 10 according to an embodiment of the present invention. In this Figure, an intermediate chamber 110 is located in fluid communication via pipe 111 with storage vessel 11. The intermediate chamber 110 is provided with a piston 112 adapted to force fluid in the intermediate chamber 110 to flow to the storage vessel 11 through the pipe 111 when the piston 112 moves in the direction indicated by arrow F3. A pump 100 may be used to assist in returning fluid to the storage vessel 11 if required.

A valve 113 is provided adjacent the outlet of the intermediate chamber 110. In use, the valve 113 is opened to allow fluid to flow from the intermediate chamber 110 to the storage vessel 11, and closed once the intermediate chamber 110 has been emptied.

In the embodiment of the invention shown in FIG. 9, a pair of evacuation chambers 19A, 19B are provided, with the evacuation chambers 19A, 19B being in different orientations to one another. Each of the evacuations chambers 19A, 19B is provided with a piston 24 mounted on a shaft 26 which is associated with the piston 112 in the intermediate chamber 110 via a line member 114 which runs over a number of pulleys 94 and is ultimately connected to a drive pulley 115 associated with shaft 26 (alternatively, screw-impellers, pumps, inflatable bladders etc could be used). Each of the evacuation chambers 19A, 19B is provided with biasing means in the form of a spring 116 (although motor, counter-weights etc may also be used) which serves to bias the pistons 24 downwardly in the case of evacuation chamber 19A and to the right in the case of evacuation chamber 19B.

In operation, when valve 95 is opened, a liquid hydrostatic pressure is exerted on the pistons 24. The pistons 24 move upwardly (in the case of evacuation chamber 19A) and to the left (in the case of evacuation chamber 19B). Shafts 26 also move, thereby turning drive pulley 115 and resulting in the line member 114 drawing the piston 112 upwardly within intermediate chamber 110. The drive pulley 115 may also be a rack and pinion gear arrangement or any other suitable arrangement.

The movement of the piston 112 causes the liquid in the intermediate chamber 110 to flow upwardly through pipe 111 when valve 113 is opened. Once the intermediate chamber 110 is empty, valve 113 closes. Pump 100 may be used to assist in returning fluid from the intermediate chamber 110 to the storage vessel 11 if required.

At other times, fluid may flow from the storage vessel 11 to the intermediate chamber 110 via pipe 111 under gravity when valve 113 is open.

Each of the evacuation chambers 19A, 19B is provided with an air inlet canister 117 that introduces air into the evacuation chambers 19A and 19B through an inlet port. Air is drawn in from the canisters 117 in response to a movement of the pistons 24 (i.e. a downward movement in evacuation chamber 19A and a movement to the right in evacuation chamber 19B). Also provided are high pressure outlet ports 118 and low pressure liquid return valves 119.

As the pistons 24 move, high pressure air on the opposite of the piston 24 to the fluid from the storage vessel 11 is forced through the outlet ports 118 through ducts 120 and into a turbine chamber 121. Air in the turbine chamber 121 flows over a turbine 122, the rotation of which can be used to generate electrical energy in a generator 123. The turbine chamber 121 is provided with a one way valve 124 to prevent the return flow of air.

When valve 95 is closed, valves 119 open, thereby causing low pressure fluid to be forced out of the evacuation chamber 19A, 19B by the biasing action of springs 116. If required, a motor or pump (not shown) may be used to assist in the movement of fluid through valves 119, although preferably this is achieved by gravity (in which case at least one of the evacuation chambers 19A, 19B is positioned above the intermediate chamber 110). Once evacuation chambers 19A, 19B are empty, valves 119 will close. This series of steps may repeat as required.

The system may be arranged in a number of different configurations. For instance, evacuation chamber 19A may act alone as the high pressure air generator feeding into the turbine chamber 121, while evacuation chamber 19B may act to generate the force required to operate piston 112 in the intermediate chamber 110. In this embodiment, the intermediate chamber 110 will receive low pressure fluid from evacuation chamber 19A as well as evacuation chamber 19B.

In an alternative arrangement, a single storage vessel 11 may be used with multiple evacuation chambers to generate high pressure air. Multiple intermediate chambers and multiple evacuation chambers may be provided to generate the force required to operate the pistons in the intermediate chambers.

The engineering computations to demonstrate the functionality of this arrangement are set out below:

Where the storage vessel is 10 m high, the pressure at points P1 or P2 is 100 kPa. For an evacuation chamber having a diameter of 600 mm and a length of 1 m, the area is 0.28 m². Force F1=Pressure×Area, thus Force F1 is 28 kN.

The intermediate chamber piston is 300 mm in diameter, with an area of 0.07 m². Force F2 is the volume in the intermediate chamber plus the pipe 111 multiplied by gravity and height. Thus, Force F2=700 kg×9.8×10=6.86 kN. This is the force to be overcome to empty the liquid in the intermediate chamber. The difference between F1 and F2 is the Force Gradient (21.14 kN).

The potential energy in the high pressure air when converted in the turbine chamber=Volume×Pressure. Thus, the available power=0.28 m³/s×100 kN/m², or the power equivalent based on a force gradient of 21.14 kN. This equates to pressure=Force/Area or 75.5 kPa. The available power is therefore equal to 0.28×75.5=21.14 kW.

Engineering computations with the use of a separate evacuation chamber to operate the intermediate chamber are set out below:

Where evacuation chamber 19A is used to generate high pressure air, P=100 kPa, A=0.28 m², V=0.28 m³ and F=28 kN. The potential energy available to be converted to power=0.28×100=28 kW.

Evacuation chamber 19B is used to generate force to operate piston 112 in the intermediate chamber 110. Thus, in a 400 mm diameter evacuation chamber, A=0.125 m², V−0.125 m³. If an evacuation chamber operational length of 1 m is used the pressure at which evacuation chamber operates is 100 kPa. Thus, the force acting on the piston=100×0.125=12.5 kN.

The total liquid flow to the intermediate chamber Q=0.28+0.125=0.405 m³. The configuration of the intermediate chamber is one having a diameter of 700 mm (A=0.385 m²) and a length of approximately 1 m. Thus, the volume is approximately 400 litres. The intermediate chamber is connected to the top of the tower at approximately 9 m in height. The diameter of pipe 111 is 250 mm (A=0.05 m²). Thus, the volume in pipe 111 is 0.45 m³.

The total volume of liquid in the intermediate chamber and the pipe 111 is 0.405+0.45=0.855 m³ (855 litres or 8.379 kN).

To move the piston 112 and thus the liquid in the intermediate chamber upwards, a force of greater than 8.379 kN will be required. As calculated above, the force generated at the evacuation chamber 19B is 12.5 kN. This is higher than the force required to be overcome at the piston in the intermediate chamber with a safety margin of 49.1%.

It is envisaged that an arrangement of multiple evacuation chambers, intermediate chambers and high pressure air cylinders may be located at any suitable height of the storage vessel. In this way, additional arrangements of chambers and air cylinders may be located above or below the first arrangement such that multiple levels may be provided.

FIG. 10 illustrates a detailed side elevation of an energy generation apparatus according to an embodiment of the present invention. The apparatus of FIG. 10 is very similar in many ways to that shown in FIG. 9. For instance the evacuation chambers 19A, 19B act in the same manner as those shown in FIG. 9 in that where piston 24 is subject to fluid transfer pressure, line member 114 and pulleys 115 are actuated, thereby forcing piston 112 to do mechanical work.

The pipe 111 in FIG. 10 is fitted with a valve 125 (such as a non-reflux valve) and a valve actuator to operate the valve 125. In the embodiment of the invention shown in FIG. 10, valves 119 are stop valves of any suitable type with non-reflux valves fitted adjacent thereto. Main valve 95 may also be any suitable type of valve.

The apparatus is provided with an intermediate chamber 126 in which low pressure fluid is stored and transferred into chamber 110. The fluid transfer may be made by any suitable technique, such as by mechanical means, electrically-operated systems or under the influence of gravity.

An outlet 129 in the form of a spout is provided in an upper region of the vessel 11 such that fluid in the upper region of the vessel 11 exits the vessel through the outlet 129. The fluid passes through a conduit 128 and a jet nozzle 127 in order to drive a turbine generator 122 to produce electricity. Conduit 128 can be of various types, shapes and configurations to allow transfer of liquid under the influence of gravity.

The potential energy of the fluid being discharged at outlet 129 is PE=mgh (in Nm) where m=the mass of fluid, g=gravity and h=the height of the vessel. The power available at the turbine generator 122 is a function of the fluid discharge rate or flow rate in N/s multiplied by head-height in m, resulting in Nm/s or J/s or kW.

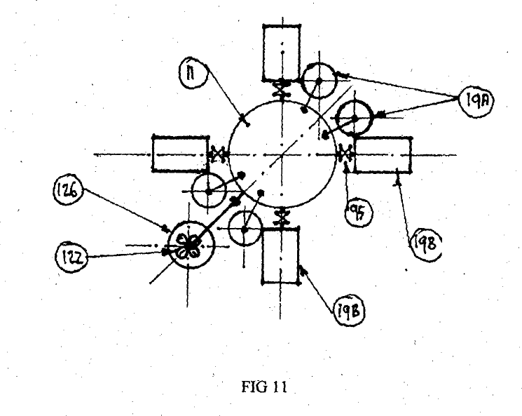

In FIG. 11 there is shown a plan view of an energy generation apparatus according to an embodiment of the present invention in which four sets of evacuation chambers 19A, 19B are shown. A single intermediate chamber 126 and turbine generator 122 is provided, although it will be understood that the apparatus could comprise varying numbers of evacuation chambers 19A, 19B and/or intermediate chambers 126 as required. The evacuation chambers 19A, 19B may be installed on one or more planes as desired. These chambers and vessels can be arranged and configured in various ways including piston therein transverses on a horizontal or a vertical plane.

The evacuation chambers 19A, 19B are adapted to provide a continuous power output. As each pair of evacuation chambers 19A, 19B requires a period of time in which to complete a repeat cycle, the operation of each pair of evacuation chambers 19A, 19B may be staggered to provide continuous power output. It is envisaged that the power output may be rated in kWh or MWh.

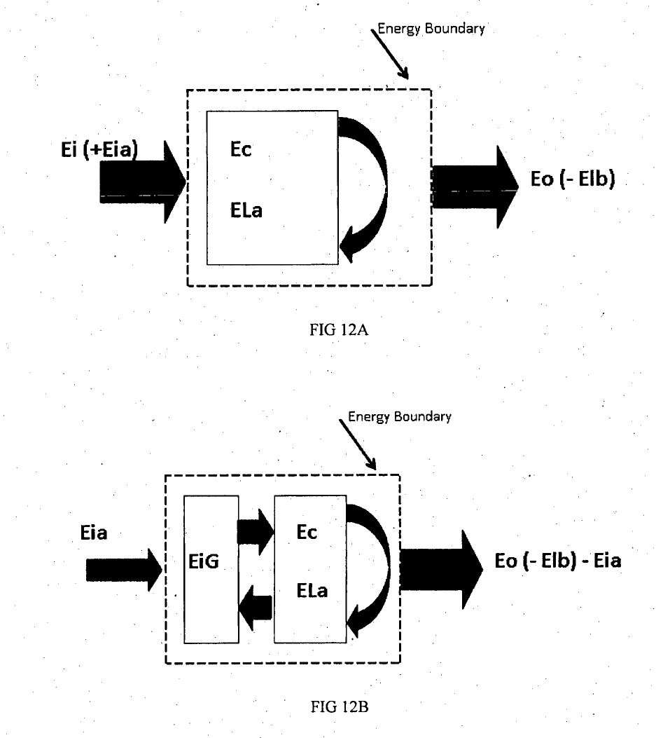

In FIG. 12A there is shown an energy and mass balance in a traditional coal fired power station. This is illustrated for comparative purposes. The variables in this Figure are as follows:

Ei=Energy Input (in the form of coal calorific values of thermal energy).

Ec=Energy converted from heat energy into kinetic energy and mechanical energy.

ELa=Parasitic load to do work; and losses due to friction and energy conversions (Ec).

Eo=Energy Output in electrical energy.

ELb=Energy Losses due to transformers, transmissions and distributions.

The energy balance for this system is set out below:

Energy and Mass Balance Formula: Ei−ELa=Eo

Net Energy Gain (NEG)=Ei−Ela.

Energy Boundary=Heat-energy from temperature gradients (AT) as medium. Incineration coal raises temperature from ambient up to 600° C. and the pressure is at 40 bar. ΔT is a variable medium that dissipates over time when Ei (+Eia)=0.

Eia (energy input-auxiliary at black start)=Gas in the form of LPG/LNG, plasma, etc.

In FIG. 12B there is shown an energy and mass balance in an energy generation apparatus according to embodiments of the present invention. The variables in this Figure are as follows:

Eia=Energy Input (in the form of electrical energy from pre-charged batteries).

EiG=Energy Input (in the form of gravitational potential energy), as in hydrodynamic-cycle.

Ec=Energy Converted from hydrostatic pressure energy into kinetic energy and mechanical energy.

ELa=Parasitic Load to do work; and losses due to friction and energy conversions (Ec).

Eo=Energy Output in electrical energy.

ELb=Energy Losses due to transmissions and distributions=0, as the present invention is a distributed system.

The energy balance for this system is set out below:

Energy and Mass Balance Formula: Net Energy Gain (NEG)=Ei−Ela.

Energy Boundary=Hydrostatic pressure-gradients (ΔP) as medium in liquid (non-thermal).

Hydrodynamic-cycle raises Weight resulting in gravitational potential energy. ΔP is a constant-medium does not dissipate over time when Ei (+EiG)=0. Buoyancy, liquid/gas density, gravity are thus constant-medium. EiG, Ec, ELa, Eo, Elb=0 in the absence of liquid, even if Eia=power active. Pressure is transferred by liquid; Force by solid-transmission; Compressed air system operated hydrostatically.

Those skilled in the art will appreciate that the present invention may be susceptible to variations and modifications other than those specifically described. It will be understood that the present invention encompasses all such variations and modifications that fall within its spirit and scope.

1. An energy generation apparatus comprising a storage vessel adapted to contain a first fluid, one or more equalisation chambers in fluid communication with the storage vessel, one or more evacuation vessels, each of the one or more evacuation vessels being divided into a first portion in fluid communication with the storage vessel and a second portion in fluid communication with a source of a second fluid, one or more intermediate chambers located between the storage vessel and the one or more evacuation vessels and energy generation means, wherein the flow of the first fluid from the storage vessel to the first portion of the evacuation vessel results in the evacuation of the second fluid from the second portion of the evacuation vessel such that the flow of the second fluid from the second portion of the evacuation vessel results in the actuation of the energy generation means.

2. An energy generation apparatus according to claim 1 wherein the first portion of the evacuation vessel comprises a chamber adapted to retain a quantity of the first fluid during a certain part of the operational cycle of the apparatus.

3. An energy generation apparatus according to claim 1 wherein the second portion of the evacuation vessel comprises a chamber adapted to retain a quantity of the second fluid during a certain part of the operational cycle of the apparatus.

4. An energy generation apparatus according to claim 1, wherein the first and second fluid are different fluids to one another.

5. An energy generation apparatus according to claim 1, wherein the second fluid is a gas or mixture of gases.

6. An energy generation apparatus according to claim 1, wherein the first and second portions of the evacuation vessel are separated from one another by a moveable barrier.

7. An energy generation apparatus according to claim 6 wherein the flow of the first fluid into the first portion of the evacuation vessel causes movement of the moveable barrier in a first direction, thereby resulting in the evacuation of the second fluid from the second portion of the evacuation vessel, and wherein a flow of the second fluid into the second portion of the evacuation vessel causes movement of the moveable barrier in a second direction, thereby resulting in the evacuation of the first fluid from the evacuation vessel.

8. An energy generation apparatus according to claim 1, wherein the energy generation means comprises rotational means associated with a generator, such that the rotation of the rotational means results in the generation of power in the generator.

9. An energy generation apparatus according to claim 1 wherein the energy generation means comprises gravitational means associated with a generator, such that the rotation of the rotational means results in the generation of power in the generator.

10. An energy generation apparatus according to claim 1, wherein the apparatus is provided with a plurality of evacuation vessels.

11. An energy generation apparatus according to claim 10 wherein the first and second portions of each of the evacuation vessels is separated from one another by a moveable barrier.

12. An energy generation apparatus according to claim 11 wherein the moveable barrier in at least one of the evacuation vessels is of a different diameter to the moveable barriers in the other evacuation vessels.

13. An energy generation apparatus according to claim 1 wherein at least one of the one or more equalisation chambers are provided with an equalising reservoir associated with an upper end of the at least one equalisation chamber.

14. An energy generation apparatus according to claim 13 wherein the equalizing reservoir is in fluid communication with both the storage vessel and the at least one equalisation chamber.

15. An energy generation system according to claim 13 wherein the equalising reservoir is provided with a moveable barrier associated with a moveable barrier in at least one of the one or more evacuation vessels.

16. An energy generation apparatus according to claim 1 wherein the one or more equalisation chambers comprise a pipe, conduit or the like attached to an external surface of the storage vessel and in fluid communication with the interior of the storage vessel through a first inlet located in an upper portion of the storage vessel and a second inlet located in a lower portion of the storage vessel.

17. An energy generation apparatus according to claim 1 wherein the one or more intermediate vessels are provided with a moveable barrier located therein.

18. An energy generation apparatus according to claim 17 wherein the moveable barrier of the one or more intermediate vessels is associated with moveable barriers in the one or more evacuation vessels such that movement of moveable barriers in the one or more evacuation vessels produces a corresponding movement in the moveable barrier in the intermediate chamber.

19. An energy generation apparatus according to claim 1, wherein a plurality of evacuation vessels are provided at different heights relative to the storage vessel.

20. An energy generation apparatus comprising a storage vessel adapted to contain a first fluid, one or more equalisation chambers in fluid communication with the storage vessel, one or more evacuation vessels, each of the one or more evacuation vessels including a piston that divides the evacuation vessel into a first chamber in fluid communication with the storage vessel, and a second chamber in fluid communication with a source of a second fluid, one or more intermediate chambers located between the storage vessel and the one or more evacuation vessels and energy generation means, wherein the flow of the first fluid from the storage vessel to the first chamber causes movement of the piston resulting in the evacuation of the second fluid from the second chamber such that the flow of the second fluid from the second chamber results in the actuation of the energy generation means.

21. An energy generation apparatus according to claim 1, wherein the dimensions of the one or more evacuation vessels are different to the dimensions of the storage vessel.

22. An energy generation apparatus comprising a storage vessel adapted to contain a first fluid, one or more evacuation vessels, each of the one or more evacuation vessels being divided into a first portion in fluid communication with the storage vessel and a second portion in fluid communication with a source of a second fluid, one or more intermediate chambers located between the storage vessel and the one or more evacuation vessels and energy generation means, wherein the flow of the first fluid from the storage vessel to the first portion of the evacuation vessel results in the evacuation of the second fluid from the second portion of the evacuation vessel such that the flow of the second fluid from the second portion of the evacuation vessel results in the actuation of the energy generation means.

23. An energy generation apparatus comprising a storage vessel adapted to contain a first fluid, one or more evacuation vessels, each of the one or more evacuation vessels including a piston that divides the evacuation vessel into a first chamber in fluid communication with the storage vessel, and a second chamber in fluid communication with a source of a second fluid, one or more intermediate chambers located between the storage vessel and the one or more evacuation vessels and energy generation means, wherein the flow of the first fluid from the storage vessel to the first chamber causes movement of the piston resulting in the evacuation of the second fluid from the second chamber such that the flow of the second fluid from the second chamber results in the actuation of the energy generation means.
